(19) United States
(12) Patent Application Publication
(10) Pub. No.: US 2025/0340286 A1
(43) Pub. Date: Nov. 6, 2025

(54) AERONAUTICAL GLAZING IN WHICH THE WHOLE OF THE SURFACE IS COVERED BY A STRONG THIN FILM ENCAPSULATED IN AN ADHESIVE INSERT LAYER

(71) Applicant: SAINT-GOBAIN GLASS FRANCE, COURBEVOIE (FR)

(72) Inventors: Adrien DUFFOUR, SULLY SUR LOIRE (FR); Michel ROUBY, SULLY SUR LOIRE (FR)

(21) Appl. No.: 18/836,473

(22) PCT Filed: Feb. 6, 2023
(86) PCT No.: PCT/FR2023/050153

§ 371 Date: Mar. 3, 2025

(30) Foreign Application Priority Data
Feb. 10, 2022 (FR) FR2201164

(51) Int. Cl. B64C 1/14; B32B 3/04; B32B 17/10

(52) U.S. Cl. CPC B64C 1/1484; B32B 3/04; B32B 17/10036; B32B 17/10201; B32B 17/1022; B32B 17/10779; B32B 2307/302; B32B 2307/412; B32B 2307/7376; B32B 2605/18

(57) ABSTRACT

A laminated glazing consisting of a first transparent sheet of mineral glass with a thickness of between 0.5 and 6 mm or of polymer material with a thickness of between 1.2 and 8 mm, intended, in the glazing mounting position, to be oriented towards the external atmosphere, and bonded to a second transparent sheet of mineral glass with a thickness of between 0.5 and 1.2 mm or of polymer material with a thickness of between 0.1 and 0.5 mm, intended to be oriented, in the glazing mounting position, towards the interior volume of the mounting structure, by a transparent adhesive insert layer with a thickness of between 0.4 and 5 mm, a strong thin film of transparent polymer material with a thickness of between 0.05 and 0.5 mm being inserted within the adhesive insert layer over the whole surface of the laminated glazing; use thereof in aeronautics.

The present invention relates to lightweight aeronautical glazings, such as for helicopters and business jets with pressurized cabins, for which two important functions are required: bird strike resistance, and failure safety in the event of breakage of the structural glass sheet.

This type of lightweight glazing usually consists of an outer sheet of glass (in contact with the external atmosphere) bonded to an inner sheet (in contact with the interior volume of the mounting structure) of strong, transparent polymer material, via an adhesive insert layer. The glass sheet is made of float, soda-lime, aluminosilicate or borosilicate mineral glass, which may be chemically strengthened, thermally tempered or toughened. The sheet of polymer material is made, for example, of Coated Polyester (CPE), such as polyester (PET) with a polysiloxane anti-scratch coating on its free face exposed to the interior volume of the mounting structure. The adhesive insert layer is preferably made of thermoplastic polyurethane (TPU), but can also be polyvinyl butyral (PVB), ethylene-vinyl acetate copolymer (EVA), casting resin or ionomer resin. An example of this type of glazing is shown in application WO 2012 085433 A1.

A bird strike occurs primarily against the outer sheet of glass, but the “bird strike” function is performed by the inner sheet of polymer material, also known as the “spall shield”: this rear polymer sheet does not tear and catches the bird.

The “fail safe” function is achieved by connecting the glazing to the mounting structure, either by a composite insert in the periphery of the adhesive insert layer, the composite insert projecting beyond at least one of the laminated glazing components, or by the adhesive insert layer projecting beyond at least one of the laminated glazing components. In the first case, the overhang of the composite insert is bonded between an outer frame and an inner frame attached to the structure; the two frames can be bolted to the structure through holes in the overhang of the composite insert and in the two frames. In the second case, the overhang of the adhesive insert layer is bonded and clamped between an outer frame and an inner frame bolted to the structure, through holes arranged in the overhang of the adhesive layer and in the two frames.

The weight of the type of glazings concerned can be optimized, while maintaining or even improving the desired mechanical properties. Secondly, the inner sheet of polymer material is not very, or not easily, functionalizable, and is fragile. The inventors set out to reduce the weight of lightweight glazings with “bird strike” and “fail safe” functions, without compromising these features.

This objective has been achieved by the invention, which, as a result, relates to a laminated glazing consisting of a first transparent sheet of mineral glass with a thickness of between 0.5 and 6 mm or of polymer material with a thickness of between 1.2 and 8 mm, intended, in the glazing mounting position, to be oriented towards the external atmosphere, and bonded to a second transparent sheet of mineral glass with a thickness of between 0.5 and 1.2 mm or of polymer material with a thickness of between 0.1 and 0.5 mm, intended to be oriented, in the glazing mounting position, towards the interior volume of the mounting structure, by means of a transparent adhesive insert layer with a thickness of between 0.4 and 5 mm, characterized in that a strong thin film of transparent polymer material with a thickness of between 0.05 and 0.5 mm is inserted within the adhesive insert layer over the whole surface of the laminated glazing.

Every transparent sheet of laminated glass is either flat or curved.

A mineral glass refers to a float, soda-lime, aluminosilicate, borosilicate, etc. glass, optionally hardened, thermally tempered, or chemically strengthened.

Transparent polymer materials include coated polyester (CPE), in particular polysiloxane-coated polyethylene terephthalate (PET) or equivalent, poly (methyl methacrylate) (PMMA), polycarbonate (PC), polyurethane (PU) and equivalents.

An adhesive insert layer here refers to polyvinyl butyral (PVB), thermoplastic polyurethane (TPU), ethylene-vinyl acetate copolymer (EVA), casting resin, ionomer resin and equivalents. Since the strong thin film is inserted within the adhesive insert layer, the invention does not preclude the possibility of sandwiching it between two different types of adhesive insert layer, e.g. between a layer of PVB and a layer of TPU. Each of the two adhesive insert layer sandwiching the strong thin film can have a number of functions: sun protection, sun shading, acoustics, in particular through a laminated structure, etc.

For the purposes of the invention, a strong thin film is tear-resistant, and it is difficult for a crack to propagate therein; one example of this is a polyethylene terephthalate (PET) film approximately 0.2 mm thick.

The strong thin film reinforces the mechanical bond between the mounting structure and the transparent part of the glazing. It provides bird strike resistance and fail safety, in the event of breakage of the first and second transparent sheets, while eliminating the peripheral composite insert and/or reducing the thickness of a glass or organic component. The result is lower manufacturing costs, and an ever-welcome reduction in the weight of the laminated glazing. The strong thin film can carry a function such as thermal control (sun protection or low emissivity), or can be totally or partially tinted (sun shading).

The invention also makes it possible to replace the inner transparent sheet (“bird strike”) of polymer material with a thin sheet of mineral glass, or other transparent element providing better mechanical strength (abrasion resistance, routine maintenance), and easier functionalization (scratch-resistant varnish, heating layers, etc.).

The functionalities sought by the invention are already obtained with a strong thin film that does not extend beyond the first and second transparent sheets. However, according to a preferred configuration of the laminated glazing of the invention, in the mounting position thereof, the free surface of the first transparent sheet is bonded at its periphery to an outer frame by means of adhesive and the free surface of the second transparent sheet is bonded at its periphery to an inner frame by means of adhesive, and the strong thin film extends beyond the edge of at least one of the first and second transparent sheets so as to extend to the edges of the outer frame and the inner frame. This arrangement increases the ability of the fastening system to hold the glazing in its bay in the event of breakage of a transparent sheet (“fail safe”) or even of all the transparent sheets (“full fail safe”), that is, to ensure that the glazing does not come loose.

According to a first embodiment of this preferred configuration, the second transparent sheet overhangs the first so as to extend, in the mounting position of the laminated glazing, up to the edges of the outer frame and the inner frame.

According to a second embodiment of this preferred configuration, in the mounting position of the laminated glazing, the outer frame and the inner frame are bolted to the mounting structure by means of a bush passing through the strong thin film, so that the glazing is clamped by the exertion of pressure by the outer frame on the first transparent sheet (via adhesive) on the one hand, and by the inner frame on the second transparent sheet (also via adhesive) on the other. This arrangement increases the degree to which the “fail safe”, “full fail safe” function can be achieved.

Preferably, the strong thin film is made of polyethylene terephthalate (PET) with a thickness of between 0.1 and 0.4, preferably between 0.12 and 0.3 and particularly preferably 0.15 and 0.25 mm, or of equivalent tenacity.

Preferably, the face of the first transparent sheet inside the laminated structure bears an electrically conductive heating layer of metal or Transparent Conductive Oxide (TCO). Examples include a metallic layer of silver, gold, indium tin oxide (ITO) or fluorine-doped tin oxide (SnO₂:F). A heating layer arranged in the thickness of the laminated structure at such a proximity to the outer surface of the glazing essentially has an anti-icing function.

According to an advantageous embodiment of the laminated glazing of the invention, the second transparent sheet is made of mineral glass and carries one or more functional layer(s)/stack(s). Such an inner sheet of mineral glass is more scratch-resistant than scratch-coated polyester. Unlike the latter, it is easy to deposit one or more thin layers in functional stacks, each a few nanometers thick, as produced by magnetic field (magnetron) assisted sputtering.

The face of the second transparent sheet facing the laminated structure then preferably carries a sun protection or low emissivity thermal control stack, and its face facing the interior volume of the mounting structure carries an anti-fog coating. A sun protection stack reflects the sun's rays, preventing the temperature inside the delimited volume from rising too high, and/or reducing glare to some extent for the pilot/driver/user/passenger/occupant. A low-emissivity stack reflects the infrared radiation corresponding to the heat of the interior volume delimited by the glazing, so as to keep more of this heat inside. An anti-fog coating consists in particular of a hydrophilic layer preventing condensation water from forming in the form of droplets, this water being deposited in the form of a homogeneous film that does not impede vision through it, is perfectly transparent and does not degrade the optical quality of the glazing. This is a layer of inorganic oxide such as silica or titanium dioxide, or a polymer such as polyurethane, polyvinylpyrrolidone or polyvinyl alcohol, formed by liquid, sol-gel or equivalent methods.

Preferably, the second transparent sheet is made of chemically-strengthened mineral glass, in particular aluminosilicate or soda-lime glass.

According to an interesting variant, a composite insert is positioned within a peripheral portion of the adhesive insert layer, facing a peripheral portion of the first transparent sheet (that is, opposite this portion of the first sheet) and extending to the edges of the outer frame and the inner frame.

Another object of the invention consists in the use of the laminated glazing disclosed above in aeronautics, as glazing for passenger aircraft, business jets (such as the Falcon F10 from Dassault Aviation) or helicopters.

The invention will be better understood in the context of the following disclosure of the appended drawings, which are schematic cross sectional depictions wherein

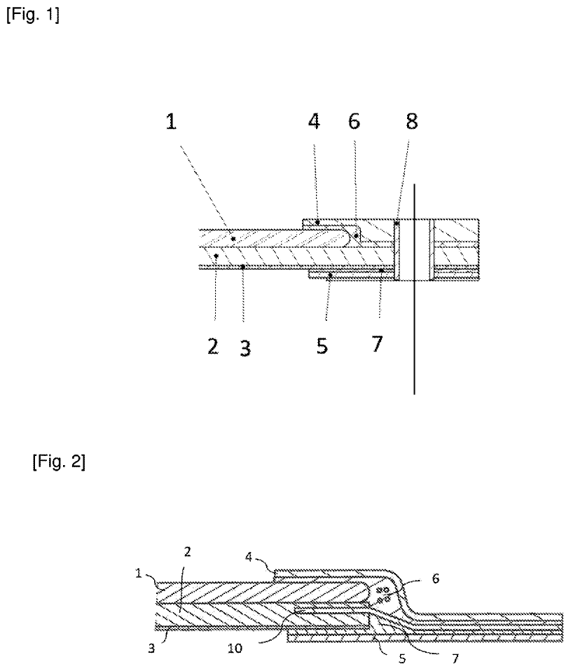

FIG. 1 and FIG. 2 show two examples of glazings of the state of the art;

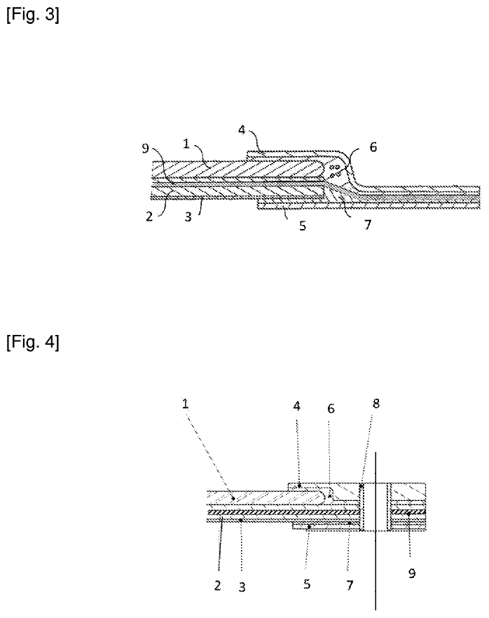

FIG. 3 and FIG. 4 are views of two variants of laminated glazings according to the invention.

With reference to FIG. 1, a laminated glazing consists of a 3 mm-thick sheet of chemically-strengthened aluminosilicate glass 1 bonded to a 0.18 mm-thick sheet of scratch-resistant coated PET 3 via a 3.8 mm-thick TPU insert layer 2. The PET sheet 3 and the adhesive layer 2 overhang the glass sheet 1. An outer frame 4 is bonded to a peripheral portion of the free surface of the glass sheet 1 and the adhesive layer 2 with adhesive 6; an inner frame 5 is bonded to a peripheral portion of the free surface of the PET sheet 3 with adhesive 7. A bush 8 is inserted through holes in the outer frame 4, adhesive 6, TPU layer 2, adhesive 7 and inner frame 5. This assembly is bolted to the mounting structure, not shown, by means of the bush 8, so that the laminated glazing is clamped under pressure by the outer frame 4 to the glass sheet 1 by means of adhesive 6, or by the inner frame 5 to the coated PET sheet 3 by means of adhesive 7.

On the contrary, the edges of all the laminated glazing components shown in FIG. 2 are substantially aligned. A composite insert 10 is encapsulated in a peripheral strip of TPU adhesive layer 2, extending between the adhesive 6 and the adhesive 7 to the edges of the outer frame 4 and the inner frame 5. Optionally and not shown, a bush as shown in FIG. 1 can also be used here, which would pass through the outer frame 4, the adhesive 6, the composite insert 10, the adhesive 7 and the inner frame 5, for the purpose of accommodating the bolting of the assembly to the mounting structure.

The laminated glazing according to the invention shown in FIG. 3 differs from that in FIG. 2 in that the composite insert 10 has been omitted, and replaced by a strong thin 0.18 mm thick PET film 9 which, in addition to the area covered by the composite insert 10, covers the entire surface of the laminated glazing. Bolting of the optional assembly, not shown, is also possible, as disclosed in relation to FIG. 2. Eliminating the composite insert 10 simplifies glazing manufacture. Compared with the use of this composite insert 10, the use of the film 9 provides bird strike and fail safe functions, while thinning the glass sheet 1, the insert layer 2 and the coated PET sheet 3, and ultimately lightening the glazing. Even using the same type and thickness of glass sheet 1 and coated PET sheet 3 as in FIGS. 1 and 2, simply replacing the adhesive insert layer 2 of the latter with a 0.18 mm-thick PET sheet (constituting the strong thin film 9) sandwiched between two 1.25 mm-thick TPU layers 2 reduces the glazing's mass per unit area by 10%, while improving its desired mechanical properties.

The glazing in FIG. 4 differs from the one in FIG. 1 in that the same PET film 9 as in FIG. 3 is encapsulated within the TPU 2 layer, also covering the entire surface of the glazing. Compared with the glazing shown in FIG. 1, the glazing shown in FIG. 4 can be fitted with lower thicknesses of glass sheet 1, adhesive layer 2 and coated PET sheet 3.

1. A laminated glazing consisting of a first transparent sheet of mineral glass with a thickness of between 0.5 and 6 mm or of polymer material with a thickness of between 1.2 and 8 mm, intended, in a glazing mounting position, to be oriented towards the external atmosphere, and bonded to a second transparent sheet of mineral glass with a thickness of between 0.5 and 1.2 mm or of polymer material with a thickness of between 0.1 and 0.5 mm, intended to be oriented, in the glazing mounting position, towards an interior volume of a mounting structure, by means of a transparent adhesive insert layer with a thickness of between 0.4 and 5 mm, wherein a strong thin film of transparent polymer material with a thickness of between 0.05 and 0.5 mm is inserted within the adhesive insert layer (2) over a whole surface of the laminated glazing.

2. The laminated glazing according to claim 1, wherein in the mounting position thereof, a free surface of the first transparent sheet is bonded at its periphery to an outer frame by means of adhesive and a free surface of the second transparent sheet is bonded at its periphery to an inner frame by means of adhesive, and the strong thin film extends beyond an edge of at least one of the first and second transparent sheets so as to extend to edges of the outer frame and the inner frame.

3. The laminated glazing according to claim 2, wherein the second transparent sheet overhangs the first transparent sheet so as to extend, in the mounting position of the laminated glazing, up to the edges of the outer frame and the inner frame.

4. The laminated glazing according to claim 2, wherein in the mounting position thereof, the outer frame and the inner frame are bolted to the mounting structure by means of a bush passing through the strong thin film, so that the laminated glazing is clamped by exertion of pressure by the outer frame on the first transparent sheet on the one hand, and by the inner frame on the second transparent sheet on the other.

5. The laminated glazing according to claim 1, wherein the strong thin film is made of polyethylene terephthalate (PET) with a thickness of between 0.1 and 0.4 or of equivalent tenacity.

6. The laminated glazing according to claim 1, wherein a face of the first transparent sheet facing the laminated structure bears an electrically conductive heating layer of metal or transparent conductive oxide.

7. The laminated glazing according to claim 1, wherein the second transparent sheet is made from mineral glass and carries one or more functional layers and/or stacks.

8. The laminated glazing according to claim 7, wherein a face of the second transparent sheet facing the laminated structure carries a sun protection or low emissivity thermal control stack, and a face of the second transparent sheet facing the interior volume of the mounting structure carries an anti-fog coating.

9. The laminated glazing according to claim 1, wherein the second transparent sheet is made from chemically strengthened mineral glass.

10. The laminated glazing according to claim 2, wherein a composite insert is positioned within a peripheral portion of the adhesive insert layer, facing a peripheral portion of the first transparent sheet and extending to the edges of the outer frame and the inner frame.

11. A method comprising providing a laminated glazing according to claim 1 in aeronautics, as a business jet or helicopter glazing.

12. The laminated glazing according to claim 5, wherein the thickness of the strong thin film made of polyethylene terephthalate (PET) is between 0.12 and 0.3.

13. The laminated glazing according to claim 12, wherein the thickness of the strong thin film made of polyethylene terephthalate (PET) is between 0.15 and 0.25.
